(19) United States
(12) Patent Application Publication
(10) Pub. No.: US 2008/0101088 A1
(43) Pub. Date: May 1, 2008

(54) HIGH-OUTPUT LIGHT GUIDE PANEL AND BACKLIGHT UNIT AND DISPLAY USING THE HIGH-OUTPUT LIGHT GUIDE PANEL

(75) Inventors: Young-chan KIM, Suwon-si (KR); Dong-ho WEE, Suwon-si (KR); Seung-ho NAM, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/830,191

(22) Filed: Jul. 30, 2007

(30) Foreign Application Priority Data
Oct. 31, 2006 (KR) 10-2006-0106728

(51) Int. Cl. F21V 8/00

(52) U.S. Cl. 362/620

(57) ABSTRACT

A high-output light guide panel and a backlight unit and display device using the high-output light guide panel are provided. The light guide panel includes a first layer having an incidence surface on which light is incident from at least one light source, an opposite surface disposed opposite the incidence surface, and an emission surface from which light is emitted; a second layer disposed on the first layer and having an emission unit in which prisms are serially and repetitively arranged; and a third layer disposed on the second layer and formed of an anisotropic material. The light guide panel also includes a plurality of light distribution controllers disposed in the second layer which totally reflect light transmitted through the first layer toward the first layer, such that the amount of totally reflected light gradually decreases from a region near the light source toward a region far from the light source.

### CROSS-REFERENCE TO RELATED PATENT APPLICATION

This application claims priority from Korean Patent Application No. 10-2006-0106728, filed on Oct. 31, 2006 in the Korean Intellectual Property Office, the disclosure of which is incorporated herein in its entirety by reference.

### BACKGROUND OF THE INVENTION

1. Field of the Invention

Apparatuses consistent with the present invention relate to a high-output light guide panel that minimizes a leak in light caused by emission of light from a higher portion and permits light to be uniformly distributed throughout the entire surface, and a backlight unit and display using the high-output light guide panel.

2. Description of the Related Art

A liquid crystal display (LCD), which is a kind of non-emissive flat panel display (FPD) used for portable computers, desktop computers, LCD-televisions (LCD-TVs), and mobile communication terminals, is not self-luminescent. Instead, the LCD selectively transmits externally irradiated light to create an image. Therefore, a backlight unit for irradiating light is installed on a rear surface of the LCD.

The backlight unit may be classified into a direct light type and an edge light type, based on the arrangement of a light source. The direct light type includes a lamp installed under an LCD to directly irradiate the LCD with light.

The direct light type is suitable for 30-inch-plus large-sized displays, such as LCD-TVs, since the light source can be disposed freely and effectively in a large area. In contrast, the edge light type is suitable for medium- and small-sized displays, such as monitors and portable phones, since the light source is disposed in a position that is restricted to an edge of a light guide panel.

FIG. 1 illustrates a light guide panel used for a related art edge light type backlight unit. Referring to FIG. 1, the light guide panel includes a light source 10, a first layer 15 formed of an isotropic material, a second layer 18 formed on the first layer 15, and a third layer 25 formed of an anisotropic material. The first layer 15 includes an incidence surface 15a on which light is incident from the light source 10, and an opposite surface 15b that is opposite to the incidence surface 15a.

The second layer 18 is an adhesive layer having a prism array 20 with a prism angle θ, and the third layer 25 is a double refraction layer whose refractive index varies with the polarization of incident light.

FIG. 2 illustrates the distribution of angles of emission light emitted from a higher portion of the light guide panel shown in FIG. 1. FIG. 3 is a graph showing the distribution of angles of vertical emission light of the light guide panel shown in FIG. 1. FIG. 4 illustrates the distribution of emission light of the light guide panel shown in FIG. 1.

FIG. 2 is a color map in which blue represents a low level of emission light, and red represents a high level of emission light. Referring to FIG. 2, it can be seen that the emission light is mostly emitted from the light guide panel vertically upward.

Referring to FIG. 3, curve “A” shows the distribution of angles of emission light measured in an X direction of FIG. 1, while curve “B” shows the distribution of angles of emission light measured in a Y direction of FIG. 1. From curve “A”, it can be seen that little light is emitted toward the opposite surface 15b, and a large amount of light is emitted in a vertical direction.

FIG. 4 is a color map in which blue represents a low level of emission light, and red represents a high level of emission light. Referring to FIG. 4, it can be observed that light is mostly emitted toward the incidence surface 15a adjacent to the light source 10.

Therefore, when the light guide panel having the prism array with serially arranged prisms is used, light is emitted in a vertical direction, without a leak in light caused by emitting light at a great angle from a higher portion of the light guide panel. However, since light is mostly emitted from the incidence surface 15a of the light guide panel, the distribution of light is not uniform.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a high-output light guide panel including a light distribution controller, which minimizes a leak in light caused by emission of light from a higher portion of the light guide panel, and permits light to be uniformly emitted from the entire surface of the light guide panel. The present invention also provides a backlight unit and display using the high-output light guide panel.

According to an aspect of the present invention, there is provided a light guide panel including a first layer having an incidence surface on which light is incident from at least one light source, an opposite surface disposed opposite the incidence surface, and an emission surface from which light is emitted; a second layer disposed on the first layer and having an emission unit in which prisms are serially and repetitively arranged; a third layer disposed on the second layer and formed of an anisotropic material; and a plurality of light distribution controllers disposed in the second layer. The light distribution controllers totally reflect light transmitted through the first layer toward the first layer, such that the amount of totally reflected light gradually decreases from a region near the light source toward a region far from the light source.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects of the present invention will become more apparent by describing in detail exemplary embodiments thereof with reference to the attached drawings in which:

FIG. 1 is a cross sectional view of a light guide panel used for a related art edge light type backlight unit;

FIG. 2 illustrates the distribution of angles of emission light emitted from a higher portion of the light guide panel shown in FIG. 1;

FIG. 3 is a graph showing the distribution of angles of vertical emission light of the light guide panel shown in FIG. 1;

FIG. 4 illustrates the distribution of emission light of the light guide panel shown in FIG. 1;

FIG. 5 is a cross sectional view of a light guide panel according to an exemplary embodiment of the present invention;

FIGS. 6A through 6C are cross sectional views of various sectional shapes of the light distribution controller shown in FIG. 5;

FIGS. 7 through 9 are plan views of various arrangements of the light distribution controller shown in FIG. 5;

FIGS. 10 through 14 are cross sectional views of light guide panels according to other exemplary embodiments of the present invention;

FIG. 15 is a cross sectional view of a display using the light guide panel shown in FIG. 5;

FIG. 16 is a cross sectional view of a display using the light guide panel shown in FIG. 13;

FIG. 17 illustrates the amount of emission light emitted from a higher portion of the light guide panel shown in FIG. 5;

FIG. 18 is a graph showing the amount of vertical emission light of the light guide panel shown in FIG. 5; and

FIG. 19 illustrates the distribution of emission light of the light guide panel shown in FIG. 5.

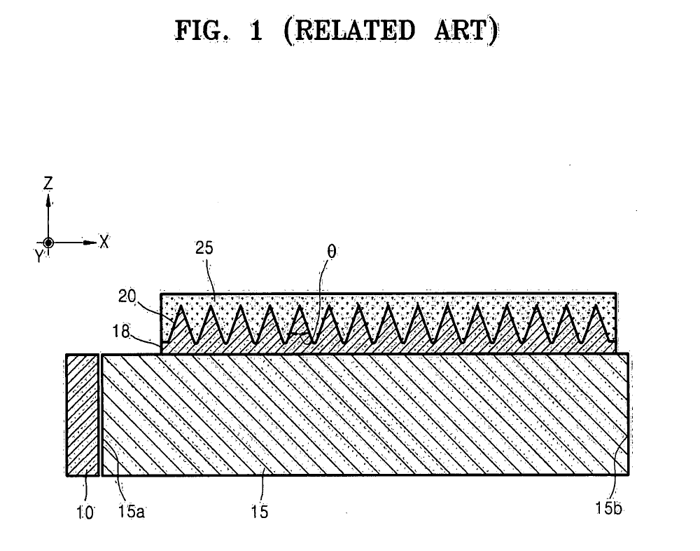

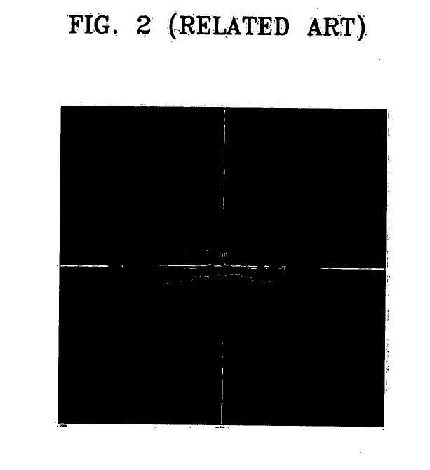

### DETAILED DESCRIPTION OF EXEMPLARY EMBODIMENTS OF THE INVENTION

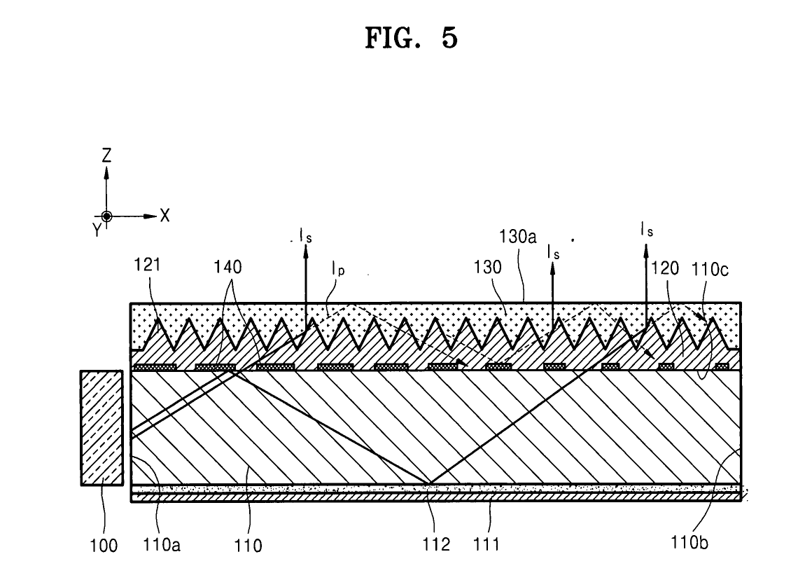

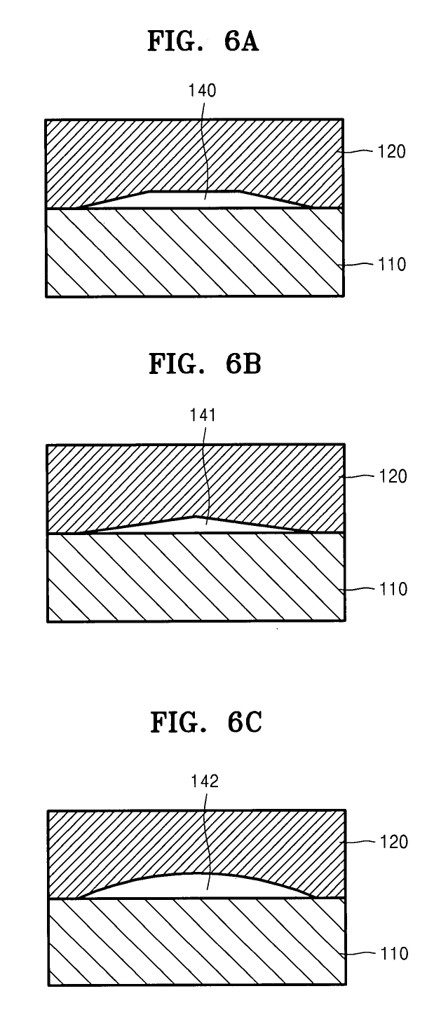

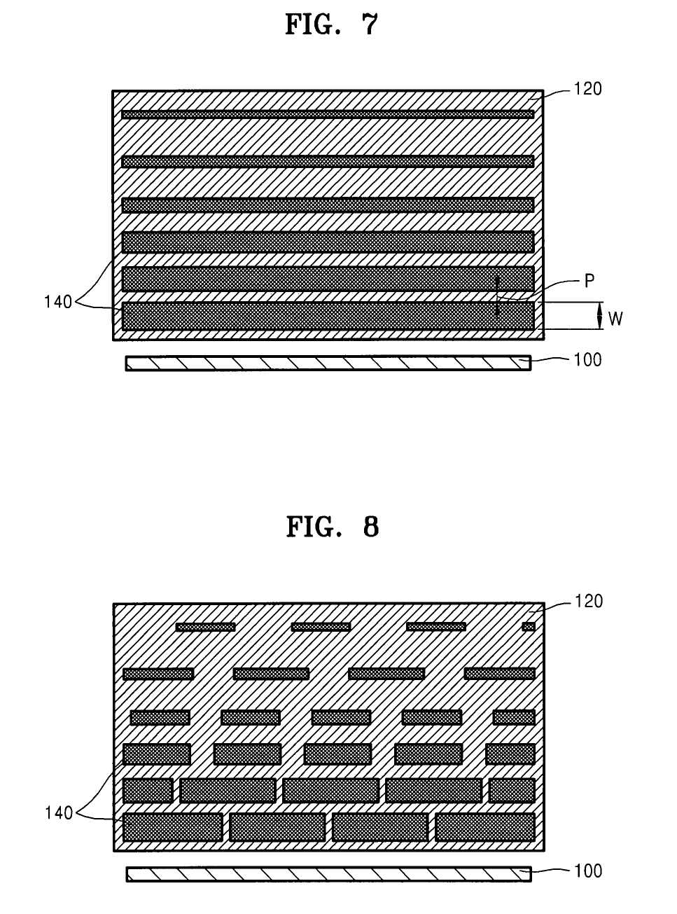

FIG. 5 is a cross sectional view of a light guide panel according to an exemplary embodiment of the present invention. FIGS. 6A through 6C are cross sectional views of various sectional shapes of a light distribution controller shown in FIG. 5. FIGS. 7 through 9 are plan views of various arrangements of the light distribution controller shown in FIG. 5.

Referring to FIG. 5, the light guide panel according to an exemplary embodiment of the present invention includes a first layer 110, a second layer 120, a third layer 130, and a plurality of light distribution controllers 140. The first layer 110 guides light emitted from a light source 100. The second layer 120 is disposed on the first layer 110. The third layer 130 is formed of an anisotropic material. Also, the light distribution controllers 140 are disposed on the second layer 120 to make the distribution of emission light uniform.

The first layer 110 includes an incidence surface 110a on which light is incident from the light source 100, an opposite surface 110b disposed opposite the incidence surface 110a, and an emission surface 110c from which light is emitted. A reflection plate 111 is disposed under the first layer 110 to reflect light that proceeds toward a lower portion of the first layer 110. Further, a polarization conversion plate 112 is disposed between the first layer 110 and the reflection plate 111 or under the first layer 110 to convert unavailable light into available light. This polarization conversion plate 112 is optional.

An emission unit 121 in which prisms are serially and repetitively arranged is disposed in the second layer 120. The second layer 120 functions as an adhesive layer for bonding the first and third layers 110 and 130 to each other. The first and second layers 110 and 120 are formed of isotropic materials with nearly identical refractive indices. For example, the first layer 110 may be formed of polymethylmetaacrylate (PMMA) with a refractive index of 1.49, and the second layer 120 may be formed of resin with a refractive index of 1.5. Alternatively, the first and second layers 110 and 120 may be integrally formed of the same material, so they have the same refractive index.

The third layer 130 is formed of an anisotropic material whose refractive index varies based on the polarization of incident light. Specifically, the third layer 130 is a double refraction layer having a first refractive index with respect to a first polarized light and a second refractive index with respect to a second polarized light. For example, the third layer 130 has a first refractive index, which is about the same as that of the first and second layers 110 and 120, with respect to P polarized light, while it has a second refractive index, which is greater than that of the first and second layers 110 and 120, with respect to S polarized light. Thus, the P polarized light is barely refracted at interfaces between adjacent layers, and directly travels through the first, second, and third layers 110, 120, and 130. The first refractive index of the third layer 130 may be equal to the refractive index of the first and second layers 110 and 120 and smaller than the second refractive index of the third layer 130. In this case, the P polarized light may travel through the first through third layers 110, 120, and 130 as if it travels through the same layer.

The light distribution controllers 140 are disposed between the emission surface 110c of the first layer 110 and the second layer 120. The light distribution controllers 140 are arranged such that a ratio of a surface area of a light distribution controller 140 to the entire surface area of the second layer 120 is greater in a region near the light source 100 (i.e., the incidence surface 110a) than a region far from the light source 100 (i.e., the opposite surface 110b) in an X direction. Each light distribution controller 140 totally reflects any incident light from the first layer 110. Therefore, more light is totally reflected toward a lower portion of the first layer 110 in the region near the light source 100, while less light is totally reflected in the region far from the light source 100.

To meet the above-described need, as shown in FIG. 7, the light distribution controllers 140 are disposed parallel to the light source 100, and the width “W” of the light distribution controller 140 becomes smaller as the light distribution controller 140 becomes farther from the light source 100. Also, an interval “P” between the light distribution controllers 140 becomes greater as the light distribution controller 140 becomes farther from the light source 100.

Referring to FIG. 8, the light distribution controllers 140 are disposed at a predetermined distance apart from one another parallel to the light source 100, and the width “W” of the light distribution controller 140 and the interval “P” between the light distribution controllers 140 may be adjusted in the same manner as illustrated in FIG. 7.

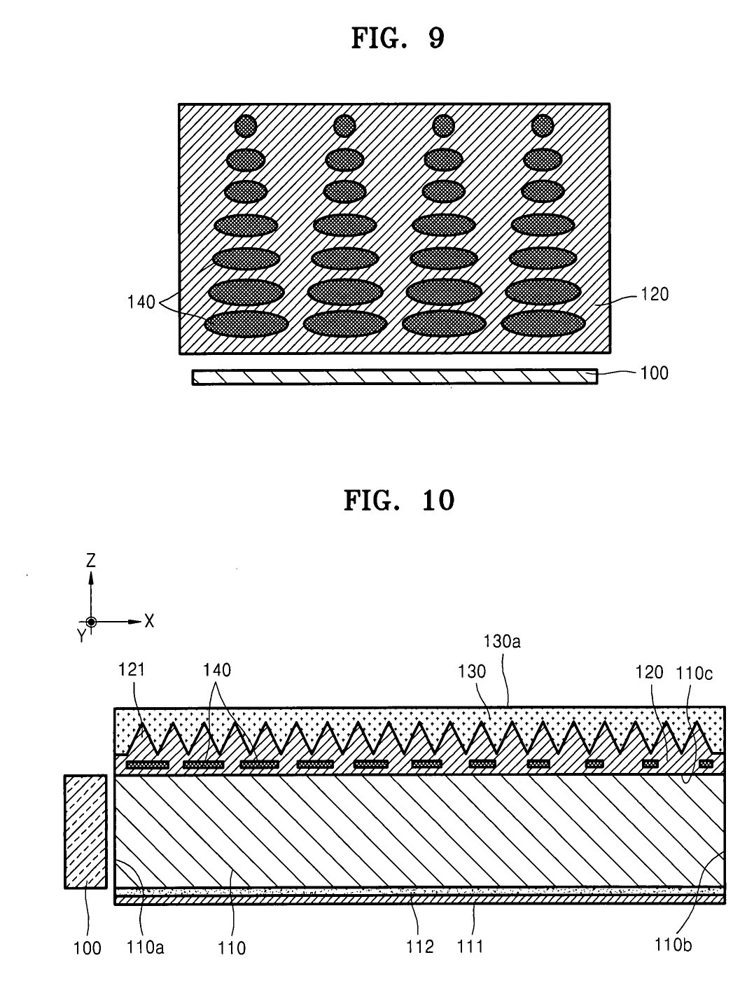

Referring to FIG. 9, a plurality of light distribution controllers 140 are arranged in the same manner as the light distribution controllers 140 shown in FIG. 8, but they have circular plane shapes, unlike the rectangular plane shapes of the light distribution controllers 140 shown in FIG. 8.

By controlling the width “W” of the light distribution controller 140 and the interval “P” between the light distribution controllers 140 as stated above, a ratio of the surface area of the light distribution controllers 140 to the entire surface area of the second layer 120 may be adjusted.

The light distribution controller 140 may have a square sectional shape as shown in FIG. 5, but the present invention is not limited thereto. Thus, the light distribution controller 140 may have a polygonal sectional shape 141 shown in FIG. 6A, a triangular sectional shape 142 shown in FIG. 6B, or an arc-like sectional shape 143 shown in FIG. 6C.

Since the light distribution controller 140 totally reflects light emitted from the first layer 110 toward a bottom surface of the first layer 110, the refractive index of the light distribution controller 140 must be smaller than the refractive index of the first layer 110 in order to satisfy the total reflection condition. Also, the light distribution controller 140 may include an air-gap. In this case, the refractive index of air is 1 and the refractive index of a material used for the first layer 110 is greater than 1, so the total reflection condition is satisfied.

The function of the light guide panel having the foregoing light distribution controllers 140 will now be described.

Light emitted from the light source 100 is incident on the first layer 110 and travels toward the opposite surface 110b. Light traveling toward the lower portion of the first layer 110 is totally reflected by the bottom surface of the first layer 110 or the reflection plate 111, and then proceeds toward a top portion of the first layer 110.

Part of the light that proceeds toward the higher portion of the first layer 110 is totally reflected by the light distribution controllers 140 and travels toward the lower portion of the first layer 110 again, while the rest of the light is refracted and transmitted through the second layer 120. Due to the above-described arrangement of the light distribution controllers 140, much light is totally reflected by the region near the light source 100. Accordingly, a large amount of light irradiated by the light source 100 is applied to the opposite surface 110b.

Light incident on the second layer 120 is transmitted through the emission unit 121 and is incident on the third layer 130. Since the third layer 130 is formed of an anisotropic material whose refractive index varies with the polarization of light, the light incident on the third layer 130 travels in different paths. When a first refractive index “ne” of first polarized light “Is” is greater than a second refractive index “no” of second polarized light “Ip” and the refractive index of the second layer 120, the first polarized light “Is” and the second polarized light “Ip” travel from the third layer 130 separately. The first polarized light “Is” is emitted from the emission unit 121 at a nearly right angle to a top surface 130a of the third layer 130 because of a difference in refractive index between the second and third layers 120 and 130. The second polarized light “Ip” is transmitted through the emission unit 121 without changing a transmission path, because there is little difference in refractive index between the second and third layers 120 and 130. The second polarized light “Ip” is incident on the top surface 130a of the third layer 130 at an angle greater than a critical angle, and totally reflected.

The second polarized light “Ip” that is totally reflected by the top surface 130a of the third layer 130 and travels downward is mostly refracted and transmitted, and returns to the first layer 110, as long as the second polarized light “Ip” does not collide with the light distribution controllers 140.

On the other hand, the second polarized light “Ip” that travels downward and collides with a top portion of the light distribution controller 140 is totally reflected, and travels back toward the emission unit 121. While the second polarized light “Ip” is being transmitted through the third layer 130 again, the time taken to pass through the anisotropic material of the third layer 130 is extended, so that the second polarized light “Ip” is partially polarization-converted. Among the polarization-converted light, the first polarized light “Is”, which makes a difference in the refractive index in the emission unit 121, is emitted at a nearly right angle to the top surface 130a of the third layer 130 to increase the amount of vertically emitted light. The second polarized light “Ip”, which makes little difference in the refractive index, is reflected by the top surface 130a of the third layer 130 and travels downward.

As a consequence, the light distribution controller 140 reflects light irradiated from the light source 100 toward the opposite surface 110b such that emission light is uniformly distributed throughout the entire light guide panel. Also, the light distribution controller 140 reflects light which is reflected by the top surface 130a of the third layer 130 and travels downward toward the top surface 130a of the third layer 130 again, so that the light is partially emitted through the top surface 130a of the third layer 130. This increases the amount of emission light. Therefore, polarization-conversion of light can be induced by the light distribution controller 140 without an additional polarization converter, thus enhancing luminous efficiency. The luminous efficiency may be maximized when the light distribution controller 140 is used along with the polarization conversion plate 112.

FIG. 10 is a cross sectional view of a light guide panel according to another exemplary embodiment of the present invention.

Referring to FIG. 10, the light guide panel has the same construction as the light guide panel shown in FIG. 5, except for the positions where the light distribution controllers 140 are installed. In the present embodiment, the light distribution controllers 140 are disposed inside the second layer 120. Since the first and second layers 110 and 120 have nearly the same refractive index, even if the light distribution controllers 140 are not disposed at an interface surface between the first and second layers 110 and 120, the light distribution controllers 140 can fulfill their functions properly.

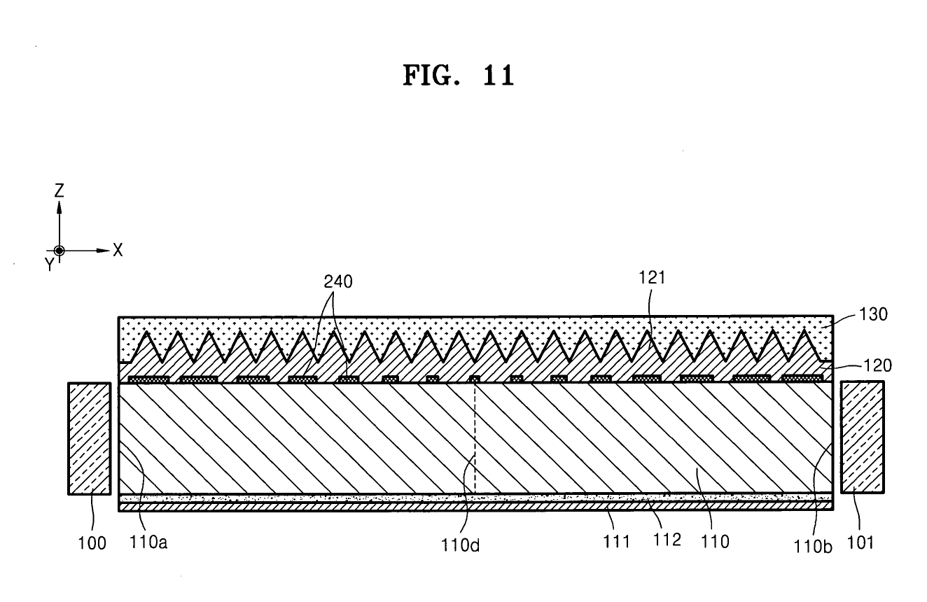

FIG. 11 is a cross sectional view of a light guide panel according to yet another exemplary embodiment of the present invention.

Referring to FIG. 11, the light guide panel includes an additional light source 101 and light distribution controllers 240 with a different construction, compared with the light guide panel shown in FIG. 5.

The first light source 100 and the second light source 101 are disposed on opposing sides of a first layer 110, and the light distribution controllers 240 are arranged symmetrically with respect to a central axis 110d of the first layer 110. A surface adjacent to the first light source 100 is referred to as a first incidence surface 110a, and a surface adjacent to the second light source 101 is referred to as a second incidence surface 110b, which corresponds to the opposite surface 110b in FIG. 5. A ratio of a surface area of a light distribution controller 240 to the entire surface area of the second layer 120 is smaller in a region near the central axis 110d than regions near the first and second incidence surfaces 110a and 110b.

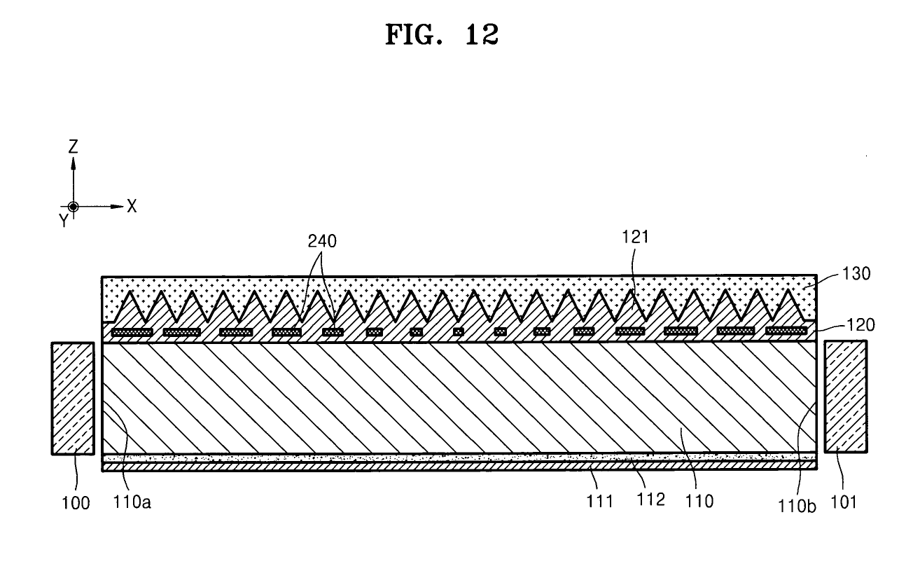

FIG. 12 is a cross sectional view of a light guide panel according to still another exemplary embodiment of the present invention.

Referring to FIG. 12, the light guide panel has the same construction as the light guide panel shown in FIG. 11, except for the positions where the light distribution controllers 240 are installed. In the present embodiment, the light distribution controllers 240 are disposed inside the second layer 120. Since the first and second layers 110 and 120 have nearly the same refractive index, even if the light distribution controllers 240 are not disposed at an interface surface between the first and second layers 110 and 120, the light distribution controllers 240 can fulfill their functions properly.

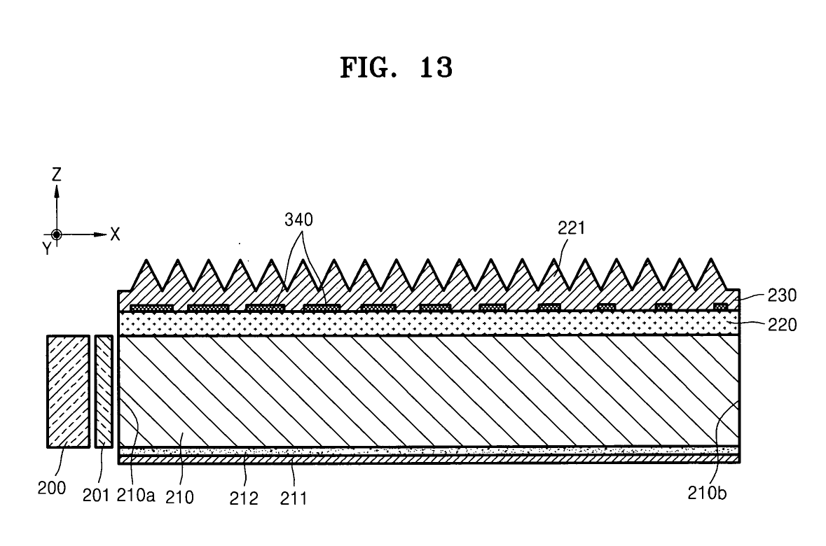

FIG. 13 is a cross sectional view of a light guide panel according to another exemplary embodiment of the present invention.

Referring to FIG. 13, the light guide panel includes a first layer 210, a second layer 220, a third layer 230, and a plurality of light distribution controllers 340. The first layer 210 guides light emitted from a light source 200. The second layer 220 is disposed on the first layer 210 and formed of an anisotropic material. The third layer 230 is disposed on the second layer 220. Also, the light distribution controllers 340 are disposed on the third layer 230 to make the distribution of emission light uniform.

The first layer 210 includes an incidence surface 210a on which light is incident from the light source 200, and an opposite surface 210b disposed opposite the incidence surface 210a. A reflection plate 211 is disposed under the first layer 210 to reflect light that proceeds toward a lower portion of the first layer 210. Further, a polarization conversion plate 212 is disposed between the first layer 210 and the reflection plate 211 to convert unavailable light into available light. A collimator 201 is disposed between the light source 200 and the first layer 210 to collimate light irradiated from the light source 200.

An emission unit 221 in which prisms are serially and repetitively arranged is disposed in the third layer 230.

The light distribution controllers 340 are disposed on the second layer 220 at an interface surface between the second and third layers 220 and 230.

Since the shape and arrangement of the light distribution controllers 340 are the same as the light distribution controllers 140 shown in FIG. 5, a detailed description thereof will not be presented here.

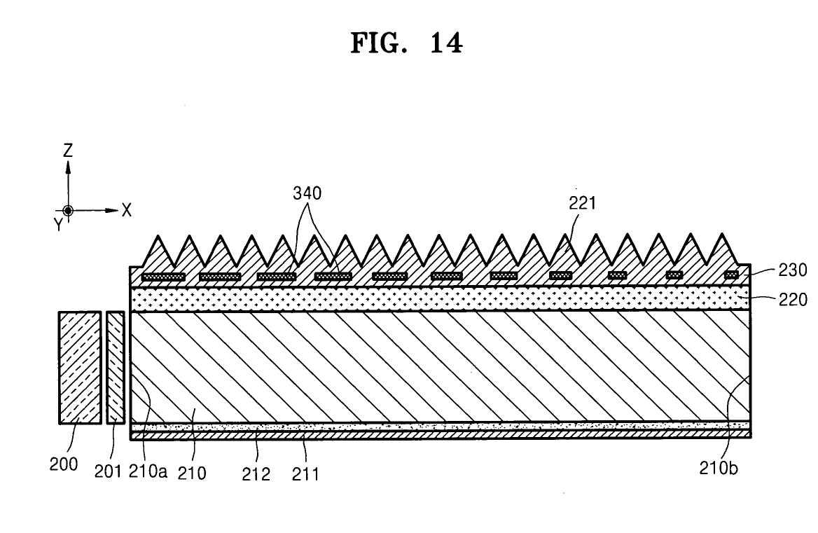

FIG. 14 is a cross sectional view of a light guide panel according to another exemplary embodiment of the present invention.

Referring to FIG. 14, the light guide panel has the same construction as the light guide panel shown in FIG. 13, except that the light distribution controllers 340 are disposed inside a third layer 230.

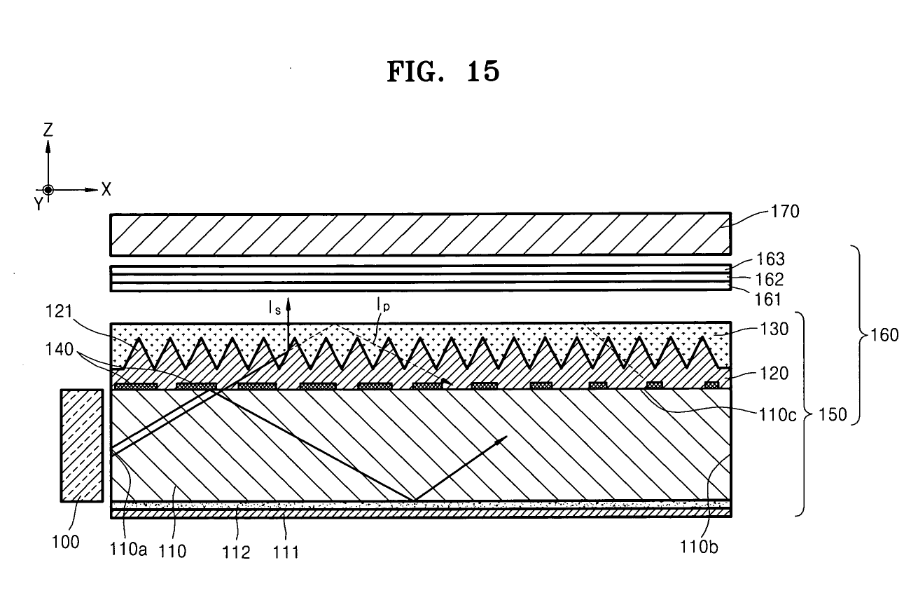

FIG. 15 is a cross sectional view of a display device using the light guide panel shown in FIG. 5.

Referring to FIG. 15, the display device includes a backlight unit 160 and a display panel 170, which forms an image by using light irradiated from the backlight unit 160. The backlight unit 160 includes a light source 100 and a light guide panel 150, which guides light irradiated from the light source 100 toward the display panel 170. Since the light guide panel 150 has the same construction and functions as described above with reference to FIG. 5, a detailed description thereof will be omitted here.

A diffusion plate 161, a first prism sheet 162, and a second prism sheet 163 are interposed between the light guide panel 150 and the display panel 170. The diffusion plate 161 diffuses light, and the first and second prism sheets 162 and 163 compensate a transmission path of light. The first and second prism sheets 162 and 163, which are arranged at right angles to each other, refract and condense light from the diffusion plate 161 to improve the directionality of light, so that the luminance of the display panel 170 can be increased and the incidence angle of light can be reduced. Also, sheets and components used between the light guide panel 150 and the display panel 170 may preserve polarization to improve performance. Further, the diffusion plate 116 and the first and second prism sheets 161 and 163 may be partially or entirely omitted.

The display panel 170 may be a liquid crystal panel that employs only specific polarized light as available light. Meanwhile, a polarization conversion plate 112 may be further interposed between the first layer 110 and the reflection plate 111.

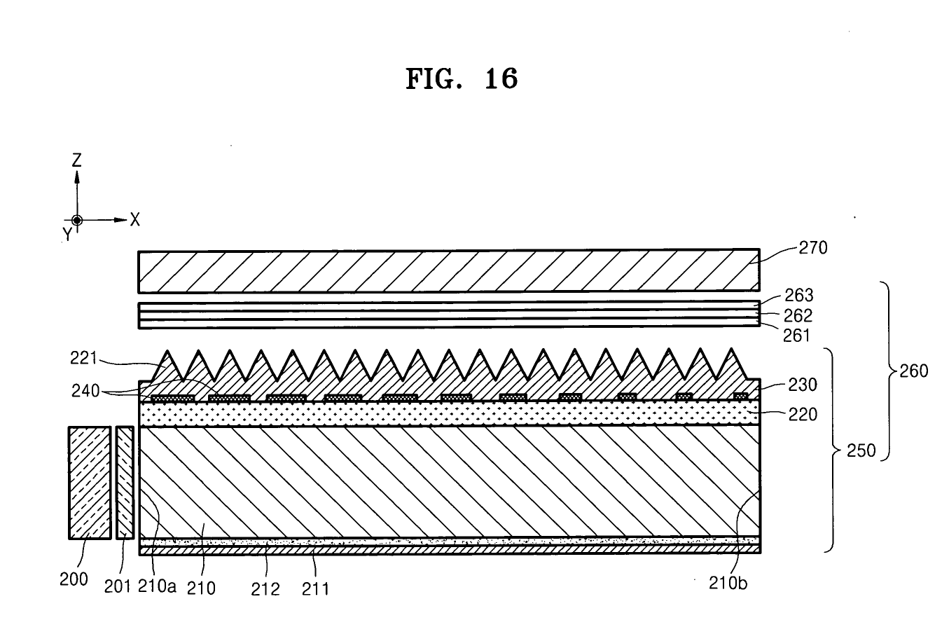

FIG. 16 is a cross sectional view of a display device using the light guide panel shown in FIG. 13.

Referring to FIG. 16, the display device includes a backlight unit 260 and a display panel 270, which forms an image by using light irradiated from the backlight unit 260. The backlight unit 260 includes a light source 200 and a light guide panel 250, which guides light irradiated from the light source 200 toward the display panel 270. The light guide panel 250 has the same construction and functions as described above with reference to FIG. 13. In FIG. 16, since the same reference numerals as used to denote the same elements as in FIG. 15, a detailed description thereof will be omitted here. A polarization conversion plate 212 may be further used between a first layer 210 and a reflection plate 211.

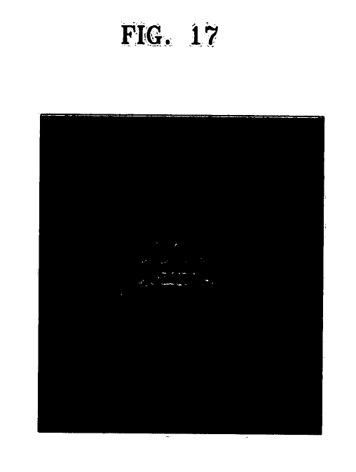

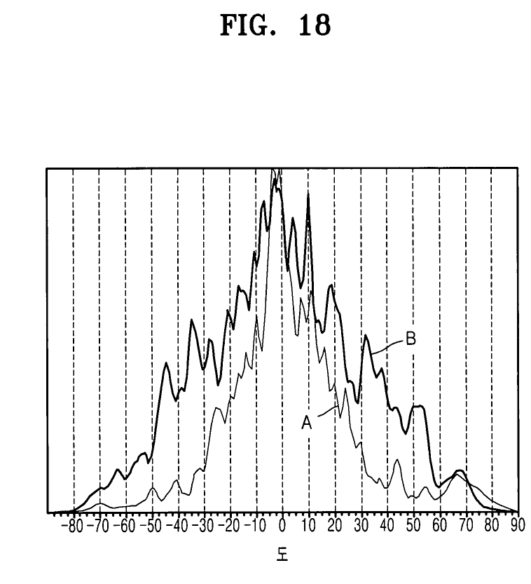

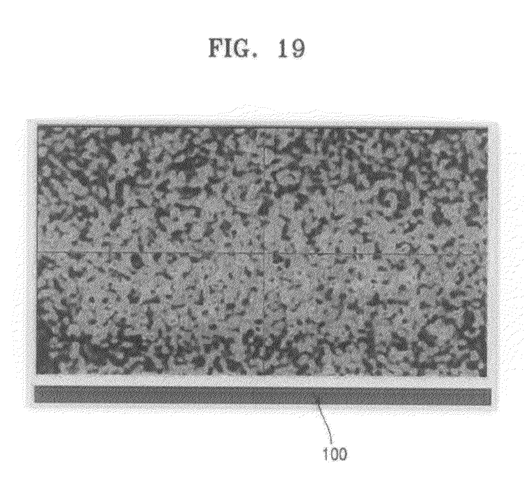

FIG. 17 illustrates the amount of emission light emitted from a top portion of the light guide panel shown in FIG. 5. FIG. 18 is a graph showing the amount of vertical emission light of the light guide panel shown in FIG. 5. FIG. 19 illustrates the distribution of emission light of the light guide panel shown in FIG. 5.

FIG. 17 is a color map in which blue represents a low level of emission light, and red represents a high level of emission light. Referring to FIG. 17, it can be observed that emission light is mostly emitted toward the center of the light guide panel.

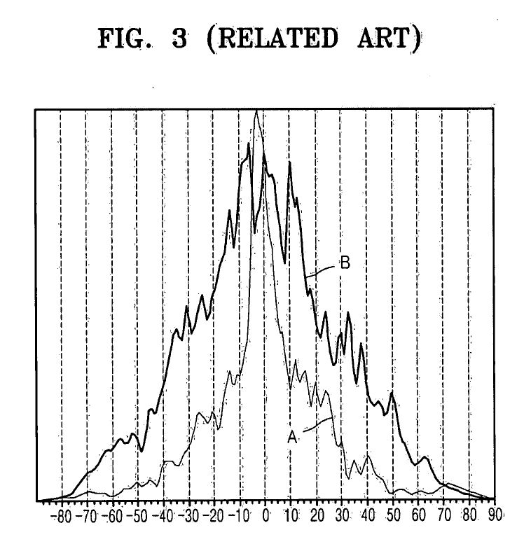

Referring to FIG. 18, curve “A” shows the distribution of angles of emission light measured in an X direction of FIG. 5, while curve “B” shows the distribution of angles of emission light measured in a Y direction of FIG. 5. From curve “A”, it can be seen that little light is emitted toward the opposite surface 110b, and a larger amount of light is emitted in a vertical direction than shown in FIG. 3. Therefore, the amount of light emitted in the vertical direction can increase, which improves the luminous efficiency.

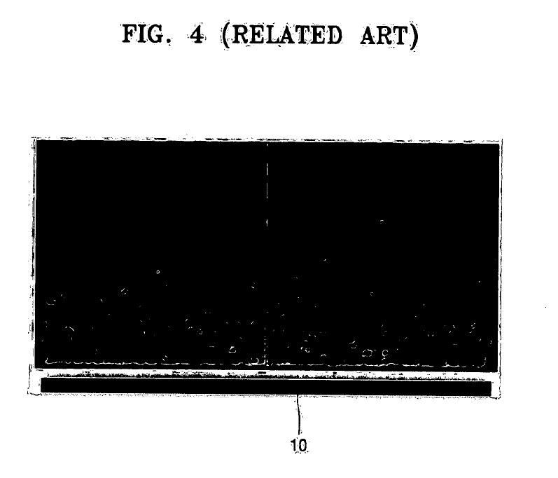

FIG. 19 is a color map in which blue represents a low level of emission light, and red represents a high level of emission light. Referring to FIG. 19, it can be observed that light is uniformly emitted from the entire light guide panel, compared with the related art light guide panel in which light is mostly emitted toward the incidence surface adjacent to the light source as shown in FIG. 4. This is because the related art light guide panel does not use the light distribution controllers 140 according to exemplary embodiments of the present invention. Therefore, emission light is made throughout the entire light guide panel by means of the light distribution controllers according to exemplary embodiments of the present invention.

According to exemplary embodiments of the present invention as described above, the light guide panel includes light distribution controllers. In this construction, a transmission path of part of light irradiated from a light source is changed to permit the light to be emitted from the entire light guide panel, thus controlling the uniformity of the distribution of emission light.

Furthermore, the light distribution controller reflects light that is not emitted from the light guide panel but is reflected into the light guide panel, back toward a top portion of the light guide panel. Thus, part of the light is polarization-converted to enhance luminous efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims and their legal equivalents.

What is claimed is:

1. A light guide panel comprising:
a first layer comprising an incidence surface on which light is incident from at least one light source, an opposite surface disposed opposite the incidence surface, and an emission surface from which light is emitted;
a second layer disposed on the first layer and comprising an emission unit in which prisms are serially and repetitively arranged;
a third layer disposed on the second layer and formed of an anisotropic material; and
a plurality of light distribution controllers disposed in the second layer;
wherein the light distribution controllers totally reflect light transmitted through the first layer toward the first layer, and the amount of totally reflected light gradually decreases from a region near the light source toward a region far from the light source.

2. The panel of claim 1, wherein the light distribution controllers are disposed on the emission surface of the first layer.

3. The panel of claim 1, wherein the light distribution controllers are disposed inside the second layer.

4. The panel of claim 2, wherein a ratio of a surface area of a light distribution controller to the entire surface area of the second layer gradually decreases from the incidence surface toward the opposite surface.

5. The panel of claim 3, wherein a ratio of a surface area of a light distribution controller to the entire surface area of the second layer gradually decreases from the incidence surface toward the opposite surface.

6. The panel of claim 4, wherein the light distribution controllers are arranged a distance apart from one another in a direction parallel to the incidence surface,
and the distance between the light distribution controllers gradually increases from the incidence surface toward the opposite surface.

7. The panel of claim 1, wherein the light distribution controllers have a sectional shape selected from the group consisting of a rectangular shape, a polygonal shape, a triangular shape, and an arc-like shape.

8. The panel of claim 1, wherein the light distribution controllers are formed of a material having a lower refractive index than a refractive index of the first layer.

9. The panel of claim 8, wherein the light distribution controllers comprise air-gaps.

10. The panel of claim 1, wherein a ratio of a surface area of a light distribution controller to the entire surface area of the second layer gradually decreases from the incidence surface and the opposite surface toward a central portion of the second layer.

11. The panel of claim 10, wherein the light distribution controllers are arranged a distance apart from one another in a direction parallel to the incidence surface,
and the distance between the light distribution controllers gradually increases from the incidence surface and the opposite surface toward the central portion of the second layer.

12. A light guide panel comprising:
a first layer comprising an incidence surface on which light is incident from at least one light source, an opposite surface disposed opposite the incidence surface, and an emission surface from which light is emitted;
a second layer disposed on the first layer and formed of an anisotropic material;
a third layer disposed on the second layer and comprising an emission unit in which prisms are serially and repetitively arranged;
a polarization conversion unit disposed on a bottom surface of the first layer; and
a plurality of light distribution controllers disposed in the third layer;
wherein the light distribution controllers totally reflect light transmitted through the second layer toward the second layer, and the amount of totally reflected light gradually decreases from a region near the light source to a region far from the light source.

13. The panel of claim 12, wherein the light distribution controllers are disposed on a top surface of the second layer.

14. The panel of claim 12, wherein the light distribution controllers are disposed inside the third layer.

15. The panel of claim 13, wherein a ratio of a surface area of a light distribution controller to the entire surface area of the third layer gradually decreases from the incidence surface toward the opposite surface.

16. The panel of claim 14, wherein a ratio of a surface area of a light distribution controller to the entire surface area of the third layer gradually decreases from the incidence surface toward the opposite surface.

17. The panel of claim 15, wherein the light distribution controllers are arranged a distance apart from one another in a direction parallel to the incidence surface,
and the distance between the light distribution controllers gradually increases from the incidence surface toward the opposite surface.

18. The panel of claim 12, wherein the light distribution controllers have a sectional shape selected from the group consisting of a rectangular shape, a polygonal shape, a triangular shape, and an arc-like shape.

19. The panel of claim 12, wherein the light distribution controllers are formed of a material having a lower refractive index than a refractive index of the second layer.

20. The panel of claim 19, wherein the light distribution controllers comprise air-gaps.

21. A backlight unit for irradiating light to a display device, the backlight unit comprising:
at least one light source;
a light guide panel which guides light incident from the light source; and
a prism sheet disposed above the light guide panel and which condenses emission light,
wherein the light guide panel comprises:
a first layer comprising an incidence surface on which light is incident from the light source, an opposite surface disposed opposite the incidence surface, and an emission surface from which light is emitted;
a second layer disposed on the first layer and comprising an emission unit in which prisms are serially and repetitively arranged;
a third layer disposed on the second layer and formed of an anisotropic material; and
a plurality of light distribution controllers disposed in the second layer;
wherein the light distribution controllers totally reflect light transmitted through the first layer toward the first layer, and the amount of totally reflected light gradually decreases from a region near the light source toward a region far from the light source.

22. The backlight unit of claim 21, wherein the light distribution controllers are disposed on the emission surface of the first layer.

23. The backlight unit of claim 21, wherein the light distribution controllers are disposed inside the second layer.

24. The backlight unit of claim 22, wherein a ratio of a surface area of a light distribution controller to the entire surface area of the second layer gradually decreases from the incidence surface toward the opposite surface.

25. The backlight unit of claim 23, wherein a ratio of a surface area of a light distribution controller to the entire surface area of the second layer gradually decreases from the incidence surface toward the opposite surface.

26. The backlight unit of claim 24, wherein the light distribution controllers are arranged a distance apart from one another in a direction parallel to the incidence surface,
and the distance between the light distribution controllers gradually increases from the incidence surface toward the opposite surface.

27. The backlight unit of claim 21, wherein the light distribution controllers have a sectional shape selected from the group consisting of a rectangular shape, a polygonal shape, a triangular shape, and an arc-like shape.

28. The backlight unit of claim 21, wherein the light distribution controllers are formed of a material having a lower refractive index than a refractive index of the first layer.

29. The backlight unit of claim 28, wherein the light distribution controllers comprise air-gaps.

30. The backlight unit of claim 21, wherein a ratio of a surface area of a light distribution controller to the entire surface area of the second layer gradually decreases from the incidence surface toward a central portion of the second layer and from the opposite surface toward a central portion of the second layer.

31. The backlight unit of claim 30, wherein the light distribution controllers are arranged a distance apart from one another in a direction parallel to the incidence surface,
and the distance between the light distribution controllers gradually increases from the incidence surface toward the central portion of the second layer and from the opposite surface toward a central portion of the second layer.

32. A backlight unit for irradiating light to a display device, the backlight unit comprising:
at least one light source;
a light guide panel which guides light incident from the light source; and
a prism sheet disposed above the light guide panel and which condenses emission light,
wherein the light guide panel comprises:
a first layer comprising an incidence surface on which light is incident from the light source, an opposite surface disposed opposite the incidence surface, and an emission surface from which light is emitted;
a second layer disposed on the first layer and formed of an anisotropic material;
a third layer disposed on the second layer and comprising an emission unit in which prisms are serially and repetitively arranged;
a polarization conversion unit disposed on a bottom surface of the first layer; and
a plurality of light distribution controllers disposed in the third layer;
wherein the light distribution controllers totally reflect light transmitted through the second layer toward the second layer, and the amount of totally reflected light gradually decreases from a region near the light source toward a region far from the light source.

33. The backlight unit of claim 32, wherein the light distribution controllers are disposed on a top surface of the second layer.

34. The backlight unit of claim 32, wherein the light distribution controllers are disposed inside the third layer.

35. The backlight unit of claim 33, wherein a ratio of a surface area of a light distribution controller to the entire surface area of the third layer gradually decreases from the incidence surface toward the opposite surface.

36. The backlight unit of claim 34, wherein a ratio of a surface area of a light distribution controller to the entire surface area of the third layer gradually decreases from the incidence surface toward the opposite surface.

37. The backlight unit of claim 35, wherein the light distribution controllers are arranged a distance apart from one another in a direction parallel to the incidence surface,
and the distance between the light distribution controllers gradually increases from the incidence surface toward the opposite surface.

38. The backlight unit of claim 32, wherein the light distribution controllers have a sectional shape selected from the group consisting of a rectangular shape, a polygonal shape, a triangular shape, and an arc-like shape.

39. The backlight unit of claim 32, wherein the light distribution controllers are formed of a material having a lower refractive index than a refractive index of the second layer.

40. The backlight unit of claim 39, wherein the light distribution controllers comprise air-gaps.

41. A display device comprising:
a backlight unit according to claim 5; and
a display panel which forms an image by using light irradiated from the backlight unit.

42. A display device comprising:
a backlight unit according to claim 25; and
a display panel which forms an image by using light irradiated from the backlight unit.

43. A display device comprising:
a backlight unit according to claim 33; and
a display panel which forms an image by using light irradiated from the backlight unit.
